(19) United States
(12) Patent Application Publication
(10) Pub. No.: US 2022/0357737 A1
(43) Pub. Date: Nov. 10, 2022

(54) Secured Network Intellingence That Contacts Help

(71) Applicant: Martez Antonio Easter, Riverdale, IL (US)

(72) Inventor: Martez Antonio Easter, Chicago, IL (US)

(21) Appl. No.: 17/300,767

(22) Filed: Nov. 1, 2021

Related U.S. Application Data
(60) Provisional application No. 63/258,515, filed on May 6, 2021.

(51) Int. Cl. G05D 1/00; G05D 1/02; H04W 4/46; H04W 4/80; G06F 21/62; H04L 9/40

(52) U.S. Cl. CPC G05D 1/0022; G05D 1/0278; H04W 4/46; H04W 4/80; G06F 21/6263; H04L 63/101

(57) ABSTRACT

An encrypted intelligence networking system that takes car to car communication/C-V2X to the next stage of vehicle safety by enhancing how auto owners report vehicles stolen, while affording law enforcement tools that allow disabling and faster detection of stolen vehicles. Secured Network Intelligence That Contacts Help (SNITCH) system, designed for installation on vehicles which require DMV registration, would rely on 4G LTE and or 5G networks to quickly transmit data through secured bluetooth features, enabling stolen vehicles to release stolen status info and other vehicle information (e.g. VIN, direction of travel, owner contact information, etc.) exclusively to law enforcement vehicles within the desired range for communication. Upon detection of a stolen vehicle, officers would have the option to activate Offender Apprehension Mode (OAM), a feature designed to disable accelerating components and prevent high-speed chases that often end with deadly crashes.

SNITCH is a system designed to provide auto owners and law enforcement around the world with a tool that combats auto theft. In this day and age we accept nothing les than the fastest internet speeds to aid us in a world of technology.

SNITCH=Innovation taking advantage of a 5G powered world . . . simple!

### STATEMENT REGARDING FEDERALLY SPONSORED RESEARCH OR DEVELOPMENT

NOT APPLICABLE

### THE NAMES OF PARTIES TO A JOINT RESEARCH AGREEMENT

NOT APPLICABLE

### REFERENCE TO SEQUENCE LISTING, A TABLE, OR COMPUTER PROGRAM LISTING COMPACT DISC APPENDIX

NOT APPLICABLE

### BACKGROUND OF INVENTION

### Section 1 OF 6

How much do you love your car? Better yet, how much do you love life itself? Sadly, many people lose their automobiles and in some cases lives are lost due to carjackings, auto thefts, and high-speed chases with law enforcement. All the aforementioned issues are topics we can't seem to avoid when turning on the news or when reading the latest newspaper. Over the past three years, auto thefts and carjackings have rose drastically. In 2019, Chicago alone saw over 500 carjackings. In 2020, that number more than doubled to 1,200 plus. This invention is meant to combat these crimes, provide reassurance to auto owners in the even their vehicle is stolen, and to save lives.

Description of information known to me as well as references to specific documents and problems involved in the prior art:
1) Car to car communication aims at increased driving comfort and safety—Google Search
2) Car to car communication technology can increase the performance of vehicle safety systems and help save lives. There were an estimated 6.8 million police reported crashes in 2019, resulting in 36,096 fatalities and an estimated 2.7 million people injured.—Google Search, car to car communication/V2V communication
3) NHTSA is dedicated to advancing the life-saving potential of vehicle technologies.—Google Search
4) The department of Transportation issued a notice of proposed rule making CNPRMS that would enable car to car/V2V communication technology on all light duty vehicles, requiring vehicles to transmit and receive standardized messages.—Google Search, what is V2V. communication?
5) 66% of Chicago Police Department chases in 2019 ended in crashes, 8 of them fatal.—Chicago Sun Times, May 13, 2021
6) There were over 1,700 reported “carjackings” throughout Chicago in 2019 and 2020.—Google Search
7) In the last 5 years, the City of Chicago paid out almost $50 million in litigation related to police pursuits and that does not account for damage to police vehicles, nor lost time due to injuries.—Chicago Sun Times, May 13, 2021
8) A 2017 U.S. Justice department report found that an average of 355 people died annually in police chases across the country between 1996-2015, a rate of one per day.—Chicago Sun Times, May 13, 2021
9) One third of those killed (355 people) were either pedestrians or motorists not involved in the chase.—Chicago Sun Times, May 13, 2021
10) Cellular vehicle to everything, or C-V2X is backed by QualComm Inc.
11) U.S. and China are taking the lead in global markets of C-V2X.
12) The 5G version of C-V2X was merged successfully in

Japan using Subaru automobiles and the mobile phone operator Softbank Cap.
13) Ford Motor Co. plans to begin deploying C-V2X models in 2022, using Explorer and Edge plus vehicles, in the U.S.
14) C-V2X was designed for 4G networks to take advantage of high data speeds and work with a variety of devices. 10-14 Wall Street Journal, May 27, 2021
15) Car-to-car/C-V2X technology can “talk” to and “listen” for similarly equipped vehicles. —Ford Motor Co., CTO Ken Washington, “How Ford is preparing today's connected vehicles for the connected world of. tomorrow.
16) Auto makers don't want to give up any spectrum to wi-fi
17) Ford conducted real-world tests in which it modified existing wi-fi equipment to use the new 45MHz spectrum. Its conclusion: Wi-fi devices' radio signals spill out into spectrums they aren't supposed to use. (16-17) Stephen Shankland, Mar. 9, 2020—Google Search.
18) False matches are a risk for license plate readers.
19) Police have been known to turn off license plate readers systems because the cameras flag so many minor violations that an officer can't keep up.
20) License plate readers spark serious talks about mass surveillance because they collect and store information indefinitely.
21) In 2015, the Illinois House passed legislation 75-24 to regulate plate reading cameras, but the bill died in the senate without being brought to vote. If's time the legislation took this issue up again. Much of the legislative work already has been done. (18-21) Chicago Sun Times, Aug. 6, 2021

### BRIEF SUMMARY OF INVENTION

### Section 2 OF 6

After a vehicle is stolen, individuals operating them ride past law enforcement daily without being detected, giving them another chance to possibly commit a crime. Most of these individuals do indeed commit other crimes using these already stolen vehicles, without being held accountable in most cases. SNITCH would be used to get stolen vehicles off the road and back to their rightful owners, before they're used to commit crimes that could end up deadly. I wish to achieve this task using both cellular and computer applications, bluetooth systems, light indicators, and other technology.

Most people within the criminal underworld believe in trading or selling stolen vehicles to evade police detection. Thinking if they blend in and avoid letting the police run the plates, they win once again. A lot of criminal individuals also believe in taking police on high-speed chases to evade capture, which could turn deadly fast. A much more complex area that strives off stolen vehicles is something called “striker plating”. This is achieved when the stolen vehicle's “VIN” (Vehicle Identification Number) is replaced with a “VIN” from a vehicle with a salvaged title or another “VIN” that isn't marked as stolen. After this process is complete, offenders either drive or sell the vehicles to other criminals. Sadly, owners may never recover their vehicles after this criminal act is accomplished.

Using the SNITCH system, owners could quickly alert any law enforcement vehicle equipped with a computer of their automobiles' stolen status, without officers having to run a plate, ever. When SNITCH is activated by a vehicle owner their vehicle would automatically communicate with any law enforcement vehicle within the desired range (e.g. 5 to 75 feet.) Since there are countless law enforcement vehicles on the road day and night, chances are offenders won't go undetected for longer than 24 hours. This invention gives officers the advantage because an offender operating the stolen vehicle won't have a clue, since the police aren't directly on their tail running their plates. Officers could keep an un-alarming distance, call for backup, and mentally prepare for the vehicle take-down.

Feature on the SNITCH system: “OAM” or Offender Apprehension Mode, is an option afforded to officers via their vehicle's computer. When officers encounter an offender operating a vehicle declared stolen by the owner, officers can then employ “OAM”. Once this feature is engaged, the stolen vehicle would gradually reduce its own speed, while employing a governor at each reduction to prevent acceleration until the vehicle is stopped.

This invention is a leap from license plate readers since they aren't installed in all law enforcement vehicles. Plate readers can't detect a vehicle that has been reported stolen, then “striker plated”. As you and I both know, license plate readers can't identify and stop a stolen vehicle if needed, they have higher error rates and are costly. Each of these weaknesses turn. into strengths when SNITCH comes into the conversation. SNITCH's use of virtual networking technology would act fast once activated, leaving criminals the least amount of time to commit another crime.

### BRIEF DESCRIPTION OF DRAWINGS

### Section 3 OF 6

NOT APPLICABLE

### DETAILED DESCRIPTION OF THE INVENTION

### Section 4 OF 6

### How Does it Work?

In the event a vehicle is stolen, the owner would be able to access an application on their phones or contact a hotline (i.e. 1-800-hot-cars) via telephone. They would then enter their exclusive passcode, answer a few security questions, activate their vehicle's bluetooth identifier, (SNITCH) and make an official police call using 911. The SNITCH system is designed to allow civilian owned vehicles equipped with SNITCH to communicate with law enforcement vehicles equipped with computers through a secured bluetooth networking feature. (i.e. There's a device called “King Fish” or “Trigger Fish” that law enforcement all over the U.S. use to combat crime. This device manipulates other devices into sending their identification information to the “King Trigger” fish device). Using similar technology, a stolen vehicle with an activated SNITCH system would only be able to release its stolen status and other information to law enforcement computers inside their cruisers when the vehicle is marked stolen by the owner. All communicating/releasing of vehicle ID information would take place when the vehicle comes within the desired range (5 to 75 feet), for a 2 to 5 second duration via bluetooth. Communication between police vehicles and stolen vehicles would still take place even if a marked vehicle is powered off.

Once desired contact is made, small indicator lights installed in the taillights or on the top of the stolen vehicle would flash green and remain illuminated for police to clearly identify a target vehicle. An arrow would also appear on the officer's computer screen, providing them with a signal direction to quickly zero in on the target vehicle. Other information such as the stolen vehicle's “VIN”, owner contact information, vehicle make, model, and color would also be provided to officers via the cruiser's computer.

### OFFENDER APPREHENSION MODE “OAM”

Since law enforcement would become aware of a stolen vehicle's status within seconds of coming into the desired range (5 to 75 feet) officers could activate the “OAM” feature and wait for the magic to happen. Offender Apprehension Mode would gradually reduce the stolen vehicle's speed: while disengaging the vehicle's cylinders/motor, employing a governor after each reduction to prevent acceleration and finally dead-locking the brakes once the vehicle reaches a safe speed (e.g. 10 to 20 mph or less).

Offender Apprehension Mode would also extend to vehicles that aren't stolen, but are potential targets for traffic stops. By using the bluetooth search feature, officers would be able to identify and lock in any vehicle within a desired range which they intend to stop. If the vehicle doesn't pull over after officers have activated their sirens, signaling the targeted vehicle to stop, then Offender Apprehension Mode will be activated to disable and eventually stop the fleeing vehicle.

Bluetooth Search—Upon officer's bluetooth search, a list of vehicles within the desired range, from closest to farthest, will be sent to law enforcement vehicles. Officers would then use this list of short range communicating vehicles to identify and lock-in on specific vehicles that are considered to be fleeing and disable them.

### APPLICATION/HOTLINE SECURITY QUESTIONS

1. Is your vehicle missing or stolen?
2. Do you want to activate your vehicle's SNITCH system?
3. Do you understand that law enforcement's job is to pursue suspects and not yours?

Please hold while you are connected with a 911 dispatch to complete a police report.

### SEQUENCE LISTING

NOT APPLICABLE

### TERMS AND DEFINITIONS

1. Car to car communication—the exchanging of information data between vehicles.
2. C-V2X—The exchanging of information/data between cellularrdevices, vehicles, and everything capable of communicating. Cellular-vehicle to everything.
3. DMV—Department of Motor Vehicles
4. Light indicators—Small lights installed on a vehicle designed to flash and illuminate
5. Offender Apprehension Mode—The combination of techniques or methods that allow law enforcement to disable a stolen vehicle electronically via computer application(s)—““OAM”;
6. Secured Network Intelligence That Contacts Help—A system designed to combat auto theft and high-speed chases with law enforcement which often end with crashes and fatalities.
7.
7. Striker Plating—A criminal technique used to replace a vehicle's “VIN” (Vehicle Identification Number).
8. Taillight Indicators—Small lights installed inside of a taillight, designed to flash and illuminate.
9. VIN—Vehicle identification number.

1. Will use bluetooth enabled devices, such as smartphones, computers, and vehicles to transmit data/information to one another to achieve car to car communication/C-V2X.

2. Will use a secured bluetooth feature designed to release data/information from a vehicle declared stolen by the owner “exclusively” to law enforcement vehicles equipped with a laptop/computer without officers having to run the stolen vehicle plates.

3. Will use “secured” smartphone applications, computer applications, and/or a customer service number to control, activate, deactivate or disable features afforded by this invention invention (Secured Network Intelligence That Contacts Help, SNITCH).

4. Will use a fully encrpted, isolated and firewalled system to prevent hacking/breaching, designed to enhance vehicle cybersecurity and vehicle data safety.

5. Will use 5G and/or 4G LTE networks for high-speed data transmission between car to car of C-V2X products and applications for short range communications.

6. Will use computer programming techniques to achieve offender apprehension mode or “OAM”, a feature designed to electronically disable accelerating components (e.g. cylinders and motors) while employing a governor at each MPH/KMH reduction, then engaging a vehicle's braking system once a safe speed is reached.

7. Will use GPS signal trajectory to determine a stolen vehicle's direction of travel, and enhance visual detection by law enforcement.

8. Will use light indicators installed on the top of a vehicle or inside the taillights that will flash and remain illuminated for law enforcement to clearly and quickly identify a target vehicle (stolen vehicle).

9. Will use passcodes and security questions provided by an auto owner to prevent application and feature misuse.
